(19) United States
(12) Patent Application Publication
(10) Pub. No.: US 2003/0230271 A1
(43) Pub. Date: Dec. 18, 2003

(54) Internal combustion engine starting device and method for driving the same

(75) Inventors: Yasuhiko Maruhashi, Chiyoda-ku (JP); Tatsumi Nishida, Chiyoda-ku (JP); Shigenori Nakazato, Hitachinaka-shi (JP); Rikio Goto, Chiyoda-ku (JP); Tadashi Sakuma, Chiyoda-ku (JP)

Correspondence Address: CROWELL & MORING LLP, INTELLECTUAL PROPERTY GROUP, P.O. BOX 14300, WASHINGTON, DC, 20044-4300, US

(73) Assignees: HITACHI, LTD.; HITACHI CAR ENGINEERNG CO., LTD.

(21) Appl. No.: 10/458,244

(22) Filed: Jun. 11, 2003

(30) Foreign Application Priority Data
Jun. 12, 2002 (JP) 2002-170777

(51) Int. Cl. F02N 17/00

(52) U.S. Cl. 123/179.3

(57) ABSTRACT

The major object of the invention is to provide an internal combustion engine stating device capable of improving cost effectiveness and quality assurance.

An starting device for internal combustion engine comprises an electric power supply path for supplying an actuator(drive unit for moving the pinion) with electric power from a battery, and an electric power supply path for supplying a motor with electric power from the battery . They are independently of each other. After the actuator is supplied with electric power from the power source and a predetermined time passes, the motor is intermittently supplied with electric power from the power source independently.

### BACKGROUND OF THE INVENTION

1. Field of the Invention

The present invention relates to an internal combustion engine starting device and a method for driving the same.

2. Prior Art

In a starter for starting an internal combustion engine, for example, an automobile engine, a pinion used for a transmission unit of a rotational driving force of a starter motor is moved in a direction of a rotary shaft of the motor by a magnetic switch, thereby it is engaged with a ring gear of an engine, and the rotational driving force of the motor is transmitted to the engine. The magnetic switch used for a driving unit of the pinion is turn-on/turn-off means for controlling the electric connection of a battery mounted in the automobile to the motor, and it is supplied with electric power from the battery to generate an attracting force. This attracting force moves a plunger in a direction opposite to a direction in which the pinion is moved, thereby the pinion moves toward the ring gear of the engine. The plunger is mechanically coupled to the pinion via a lever.

The electric power supplied to the magnetic switch from the battery is supplied to the motor via a coil of the magnetic switch. Thereby when the pinion is moved, a large current is flowed through the coil of the magnetic switch. This increases the attracting force generated in the magnetic switch, and the plunger abruptly moves toward the ring gear of the engine and heavily collides with the ring gear.

Therefore, a conventional internal combustion engine starting device, as described in Japanese Patent Laid-Open No. 2000-64935, for example, a cushion spring is interposed between the pinion and a pinion shaft to decrease an impact force generated when the pinion collides with the ring gear of the engine.

Further, a conventional internal combustion engine starting device is provided with an electromagnetic switching device described in Japanese Examined Utility Model Publication No. S63(1988)-38382 to avoid a heavy collision of the pinion with the ring gear of the engine. That is, in the conventional internal combustion engine starting device described in the official gazette, the electromagnetic switching unit is provided with a voltage coil for moving the plunger to a state where the pinion hits against the ring gear of the engine and a current coil for moving the plunger from the state where the pinion contacts with the ring gear to a state where the pinion is engaged with the ring gear. And after the pinion is made hit against the ring gear by excitation of the voltage coil, the current coil is excited with high electric power, thereby an initial exciting electric power is suppressed.

Still further, in Japanese Examined Utility Model Publication No. 63-38382, the electromagnetic switching device is provided with a delay circuit for delaying a signal after a key switch is turned on until the pinion contacts with the ring gear. With this delay circuit, as a supply of a current to the motor is stopped after the key switch is turned on until the pinion contacts the ring gear, the impact force produced when the pinion is engaged with the ring gear is decreased.

[Problems to Be Solved by the Invention]

In recent years, in the industrial field of an automobile, from the viewpoint of environmental protection or global warming prevention, an idle stop system, which stops an engine to suppress the emission of an exhaust gas when a vehicle stops to wait at traffic signals, is examined. In the idle stop system, every time the vehicle is stopped, the engine is stopped, and when the vehicle is restarted, the engine is restarted. Hence, the number of starting the engine is increased more than ever. For this reason, it is necessary to improve the durability of a starter and to elongate its life more than ever. Moreover, from the viewpoint of cost effectiveness and flexibility in mounting the starter on the vehicle, it is desirable to reduce the size, weight, and cost of the starter and to elongate its life.

In the former device described above, however, the cushion spring is interposed between the pinion and the pinion shaft, so that parts such as stopper member and machining the parts are required and an assembling work of the starter becomes complicated. For this reason, this device can decrease the impact force generated when the pinion collides with the ring gear of the engine but increases manufacturing cost. Therefore, the former device still has a problem that it cannot compatibly achieve the reduced cost and the elongated life.

On the other hand, the latter device described above decreases the impact force generated when the pinion collides with the ring gear of the engine and further decreases the impact force generated when the pinion is engaged with the ring gear, so that it is effective for elongating the life of the starter. The latter device described above, however, does not go so far as to control a rise of rotation of the pinion, hence cannot decrease the impact force generated when the pinion is engaged with the ring gear more than ever. That is, it is not taken into account that the pinion is surely engaged with the ring gear of the engine, so in a case where the motor is driven in a state where the pinion is not engaged with the ring gear, a rotational impact force is generates between the pinion and the ring gear.

Further, in the latter device described above, a part of the electromagnetic switching unit for controlling the electric connection of the battery mounted on the automobile to the motor is constructed of a mechanical contact. For this reason, the mechanical contact is worn away by passing a current through the motor from the battery by a turn-on/turn-off control and hence as the number of starter of the engine increases, its life is made shorter. In this manner, the latter device described above still has a problem in elongating the life of the starter.

Still further, in the latter device described above, the electromagnetic switching unit has two coils and has the delay circuit built therein so as to decrease the impact force generated when the pinion collides with the ring gear and the impact force generated when the pinion is engaged with the ring gear of the engine, so that the electromagnetic switching unit is increased in size. Moreover, in a case where the electromagnetic switching unit is arranged near a high-temperature part such as an exhaust pipe, in order to protect the delay circuit from the high temperature, the electromagnetic switching unit needs to be provided with heat resistant means such as constructing the electromagnetic switching unit of a high-heat resistant material and hence cannot be standardized. Therefore, the latter device described above still has problems in reducing the size, weight, and cost of the starter.

### SUMMARY OF THE INVENTION

The object of the invention is to provide an internal combustion engine starting device capable of improving cost effectiveness and quality assurance and a method for driving the same. Further, the object of the invention is to provide an internal combustion engine starting device capable of improving the reliability and cost effectiveness of an automobile to which an idle stop system is applied and a method for driving the same. Still further, the object of the invention is to provide an internal combustion engine starting device capable of being reduced in its size, weight, and cost, and increasing its life, and a method for driving the internal combustion engine starting device.

[Means for Solving the Problems]

A basic feature of the invention is as follows.

The internal combustion engine starting device comprises a rotational electric machine that generates a rotational driving force for starting the engine, a transmission unit that transmits the rotational driving force to a power transmitting part of the engine side, a driving unit that moves the transmission unit toward the power transmitting part of the engine side on a rotary shaft of the rotational electric machine.

And an electric power supply path for supplying the rotational electric machine with electric power from the power source and an electric power supply path for supplying the driving unit with electric power from the power source are mutually constituted independently. Thereby, a supply of electric power from the power source to the rotational electric machine and a supply of electric power from the power source to the driving unit are independent of each other.

According to the invention, the electric power supply path for supplying the rotational electric machine with the electric power from the power source and the electric power supply path for supplying the driving unit with the electric power from the power source are constructed independently of each other, so that the electric power supplied from the power source to the driving unit is not supplied to the rotational electric machine. With this construction, it is possible to reduce a current passing through the driving unit and hence to reduce the driving force of the driving unit. Thus, it is possible to decrease the moving speed of the transmission unit moving toward the power transmitting part of the engine side.

Therefore, according to the invention, it is possible to decrease an impact force generated when the transmission unit collides with the power transmitting part of the engine side without providing the transmission unit with a means for decreasing an impact force.

In addition, according to the present invention, it is sufficient that the driving unit generates only a driving force of such a level that can move the transmission unit to the power transmission part of the engine side and can hold the state of contact of the transmission unit to the power transmitting part of the engine side. Thus, it is possible to reduce the size of the driving unit than usual and to simplify the construction of the driving unit. Further, according to the invention, the rotational electric machine is supplied with the electric power from the power source not through the driving unit. Therefore, the driving unit has no use a mechanical contact and hence further to miniaturize and simplify the driving unit and to improve the durability of the driving unit.

The electric power supply path for supplying the rotational electric machine with the electric power from the power source is provided with a control means for controlling the supply of electric power to the rotational electric machine from the power source according to the state of supply of electric power to the driving unit from the power source. To be more specific, the control means is switching means that delays intermittent electric power from the power source and supplies it to the rotational electric machine according to the state of supply of electric power supplied from the power source to the driving unit. The switching means is constructed of a switching element that is provided in the electric power supply path for supplying the rotational electric machine with the electric power from the power source and a control circuit that delays the intermittent electric power and supplies it to the switching element according to the state of supply of electric power supplied to the driving unit from the power source.

As the present invention is provided the above-mentioned switching means, the delayed intermittent electric power is supplied to the rotational electric machine from the power source.

For example, after electric power is supplied to the driving unit from the power source and a predetermined time passes, intermittent electric power having delay is supplied to the switching element, thereby the rotational electric machine is intermittently supplied with delayed electric power from the power source.

Or assuming that a passing time after the transmission unit started moving in the direction of the shaft until it reaches the power transmitting part is Tm; assuming that a passing time after the power source started supplying the driving unit with electric power until the power source starts to supply the rotational electric machine with electric power is Tp, the power source supplies the driving unit with electric power such that a relationship of

Tp≧Tm

is satisfied, and then intermittent electric power having delay is supplied to the switching element, thereby the rotational electric machine is intermittently supplied with delayed electric power from the power source.

Or after electric power started supplying to the driving unit from the power source, intermittent electric power having delay is supplied to the switching element, thereby the rotational electric machine is intermittently supplied with delayed electric power from the power source.

According to the invention, the intermittent electric power from the power source is delayed and supplied to the rotational electric machine by the above-mentioned switching means according to the state of supply of electric power supplied to the driving unit from the power source. That is, after the key switch is turned on and the transmission unit is moved to be made hit against the power transmitting part of the internal combustion engine side, the power source supplies the rotational electric machine with the intermittent electric power. Thus, it is possible to decrease the impact force generated when the transmission unit is mechanically engaged with the power transmission part of the engine side. Moreover, in a case where the transmission unit is not yet mechanically engaged with the power transmitting part of the engine side, by intermittently driving the rotational electric machine with the intermittent electric power, it is possible to mechanically engaged the transmission unit with the power transmitting part of the engine side with reliability and in a state where the rotational impact force between the transmission unit and the power transmitting part is decreased.

The power source has its output voltage set higher than the input voltage of the rotational electric machine, or is constructed of a first power source and a second power source that are different from each other in an output voltage. In a case where the output voltage of the power source is higher than the input voltage of the rotational electric machine, the rotational electric machine is supplied from the power source with electric power having a decreased voltage. On the other hand, the driving unit is supplied with the electric power as it is supplied from the power source. In a case where the power source is constructed of the first power source and the second power source that are different from each other in the output voltage, the rotational electric machine is supplied with the electric power from the first power source. The driving unit is supplied with the electric power from the second power source having the output voltage higher than the first power source.

According to the present invention, as the driving unit can be supplied with the electric power having voltage higher than the electric power supplied to the rotational electric machine, the driving force of the driving unit can be increased. Therefore, according to the invention, it is possible to provide the driving unit with a predetermined driving force (a driving force of such a level that can move the transmission unit to the power transmission part of the engine side and can hold a state where the transmission mechanism contacts against the power transmitting part of the engine side) and to further reduce the size of the driving unit.

The switching means of control means is located separately from the driving unit and the rotational electric machine. Thereby, the switching means can be located at a position away from a high-temperature region around the internal combustion engine with the driving unit and the rotational electric machine. Thus, it is possible to improve heat resistance of the switching means of the control means without the switching means having heat resistant process. Therefore, according to the invention, it is possible to standardize the switching means.

Moreover, in the invention, the current duty factor of the electric power supplied to the rotational electric machine is set 80% or less, preferably, 20%. Further, in the another invention, the amount of current of the electric power supplied to the rotational electric machine is set constant for a predetermined time after the supply of electric power to the rotary electric power is started. Then, after the predetermined time has passed, the amount current of the electric power supplied to the rotational electric machine is gradually increased.

### BRIEF DESCRIPTION OF THE DRAWINGS

FIG. 1 is a circuit diagram showing the electric circuit configuration of an internal combustion engine starting device that is a first embodiment of the invention.

FIG. 2 is a cross-sectional view showing the construction of an actual internal combustion engine starting device to which the electric circuit configuration shown in FIG. 1 is applied and shows a state where the internal combustion engine starting device is stopped (a state where a pinion of a power transmission mechanism is not engaged with a ring gear of a power transmission part of an internal combustion engine of an automobile).

FIG. 3 is a cross-sectional view showing the construction of the actual internal combustion engine starting device to which the electric circuit configuration shown in FIG. 1 is applied and shows a state where the internal combustion engine starting device is operated (a state where the pinion of the power transmission mechanism is engaged with the ring gear of the transmission part of the internal combustion engine of the automobile).

FIG. 4 is a flow chart showing the operations of the internal combustion engine starting device shown in FIG. 1 and shows a series of operations from the time when an ignition key switch is turned on to the time when the starting of the internal combustion engine of the automobile is completed.

FIG. 5 is a time chart showing the operations of the pinion that is the power transmission mechanism and a power switching unit that is control means provided in an electric power supply system, of the internal combustion engine starting device shown in FIG. 1, and shows a series of operations from the time when the ignition key switch is turned on to the time when the internal combustion engine of the automobile is rotated and driven.

FIG. 6 is a circuit diagram showing the electric circuit configuration of an internal combustion engine starting device that is a second embodiment of the invention.

FIG. 7 is a circuit diagram showing the electric circuit configuration of an internal combustion engine starting device that is a third embodiment of the invention.

### DESCRIPTION OF THE PREFERRED EMBODIMENTS

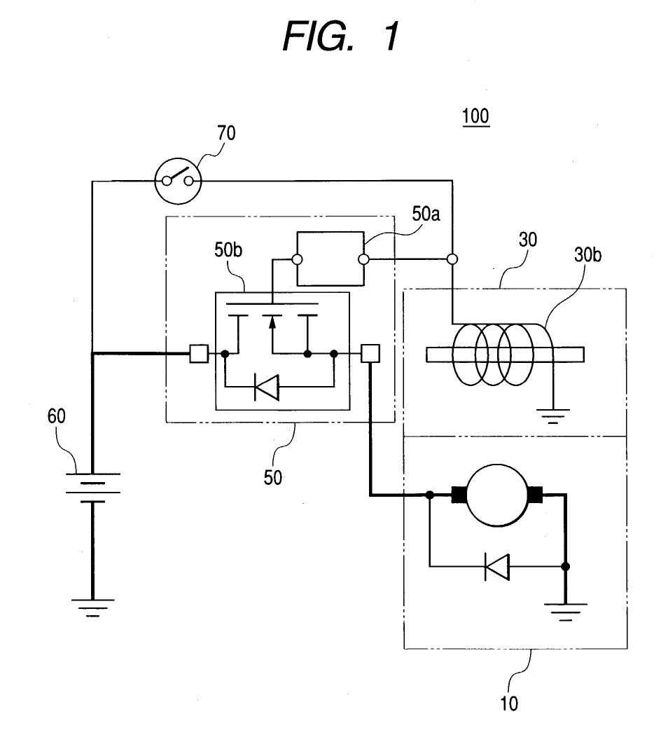

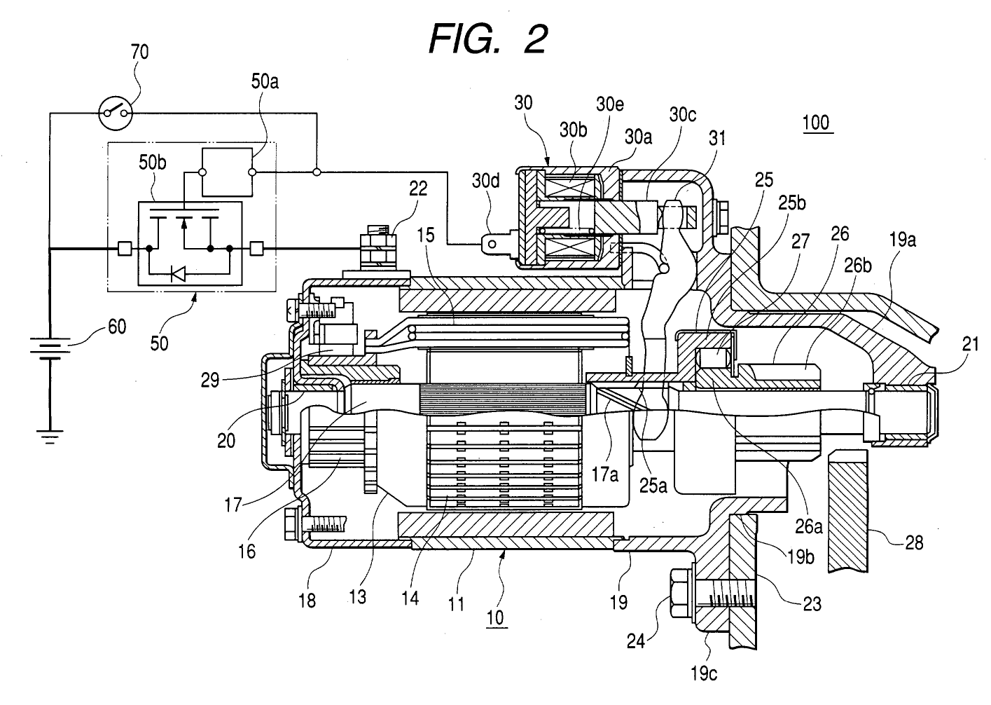

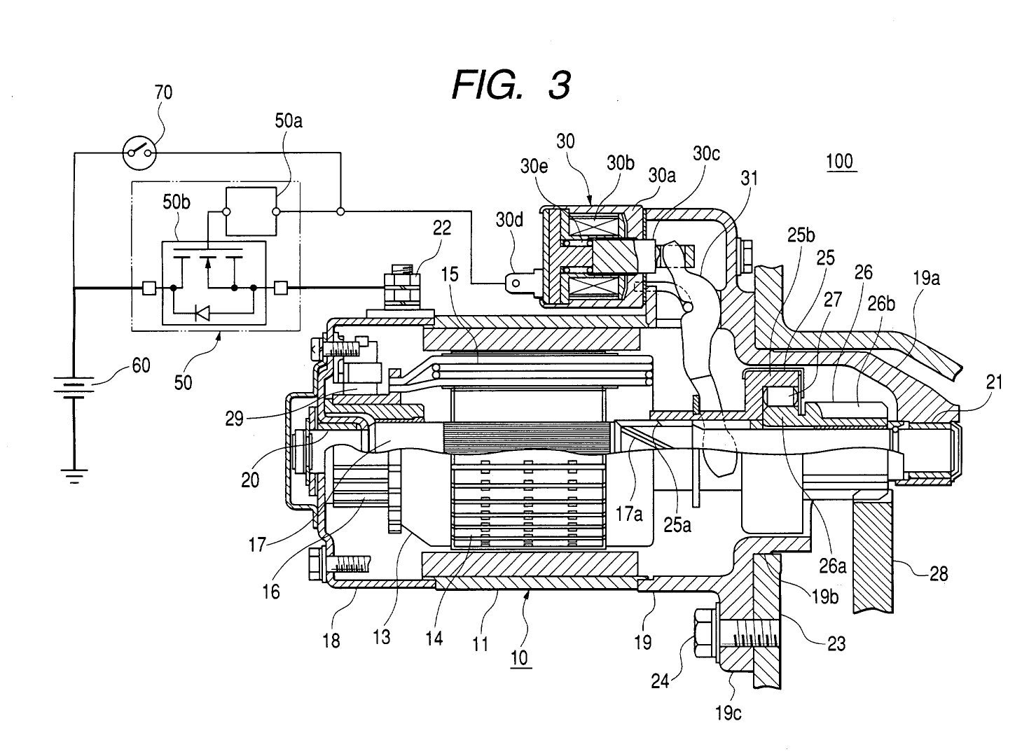

A first embodiment of the invention will be described with reference to FIG. 1 to FIG. 5. FIG. 1 shows an electric circuit configuration of an internal combustion engine starting device of the first embodiment of the invention. FIG. 2 and FIG. 3 show the construction of an actual internal combustion engine starting device to which the electric circuit configuration shown in FIG. 1 is applied. The internal combustion engine starting device of the present embodiment is a starter of an automobile engine driven by using fuel, for example, gasoline. A starter 100 is roughly comprised of a motor 10 including a transmission unit (transmission mechanism), an actuator 30 including a shift lever 31, a power switching unit 50, an ignition key switch 70, and a power supply system including a power source.

The motor 10 is a DC rotational electric machine (ex. DC motor). It is supplied with a DC electric power from a battery 60 (an automobile-mounted power source) having an output voltage of 12 V and generates a rotary driving force for starting an automobile engine. A field stator 12 is located on the inner peripheral side of a cylindrical yoke 11 constituting the outer case of the motor 10, and it constitutes a magnetic circuit with the yoke 11. The field stator 12 has a plurality of field cores fixed with screws to the inner peripheral side of the yoke 11 and field winding wound on the respective field cores.

A rotor 13 (armature) is rotatably located in the inner peripheral of the field stator 12 via a predetermined gap. The rotor 13 has a rotor core 14 having a plurality of slits on its outer peripheral side. Each slit of the rotor core 14 receives a rotor winding 15 (armature winding). A commutator 16 electrically connected to the rotor winding 15 is located on one end side of the rotor core 14. A transmission mechanism that will be described later is located on the other end side of the rotor core 14. A brush 29 held and pressed by a brush holder is put into slidable contact with the commutator 16. The brush 29 is electrically connected to the field winding via a brush lead wire or the like and supplies the commutator 16 with electric power from the battery 60 via the field winding. The electric power supplied to the commutator 16 is supplied to the rotor winding 15.

The rotor core 14, the commutator 16, and the transmission unit are provided on a rotary shaft (or output shaft) 17. The one end side of the yoke 11 is covered with a rear bracket 18 and the other end side of the yoke 11 is covered with a front bracket 19. Both ends of the rotary shaft 17 is rotatably born by a bearing 20 provided in the rear bracket 18 and a bearing 21 provided in a nose portion 19a of the front bracket 19.

An electric power receiving terminal 22 is provided on the outer peripheral side of the rear bracket 18. The terminal 22 is protruded outward from the outer peripheral surface of the rear bracket 18 and is electrically connected to the field winding of the field stator 12 and can be electrically connected to the battery 60 via a power switching unit 50. The front bracket 19 has a spigot portion 19b and a flange portion 19c. The starter 100 is mounted on the engine of the automobile by fitting the spigot portion 19b into a starter mounting portion 23 and fixing the flange portion 19c to the starter mounting potion 23 with a bolt 24.

On the rotary shaft 17 is provided the transmission unit for transmitting a rotational driving force generated by the motor 10 to a ring gear 28. The ring gear 28 is a power transmission part of the engine side of the automobile. The transmission unit is constructed of a roller clutch 25 and a pinion 26. The roller clutch 25 is constructed such that it is supplied with a driving force from the outside, thereby being slid (moved) on the rotary shaft 17, and its helical spline 25a formed on its inner peripheral surface is engaged with a helical spline 17a formed on the outer peripheral surface of the rotary shaft 17. The pinion 26 sliding (moving) on the rotary shaft 17 with the roller clutch 25 is provided on the opposite side of the rotor 13 side of the roller clutch 25. The roller clutch 25 is combined with the pinion 26 via a roller 27 interposed between the outer portion 25b of the roller clutch 25 and the inner portion 26a of the pinion 26. The pinion 26 is provided with a pinion gear 26b to be engaged with or disengaged from the ring gear 28.

The actuator 30 is a driving unit that is supplied with DC electric power from the battery 60 to generate the driving force of the transmission unit. A solenoid coil 30b is wound on the inner peripheral side of a cylindrical core 30a constituting the outer cover of the actuator 30. A plunger 30c of a moving conductive body is provided on the inner peripheral side of the core 30a. The plunger 30c is attracted into the actuator 30 by an electromagnetic force (attracting force) generated when the solenoid coil 30b is supplied with the electric power. For this reason, the actuator 30 is also called an electromagnetic induction element or sometimes also called a solenoid. One end side in the axial direction of the actuator 30 (side opposite to the protruding side of the plunger 30c) is closed. An electric power receiving terminal 30d is provided on this closed portion. The electric power receiving terminal 30d is protruded outward from the surface of the closed portion and is electrically connected to the solenoid coil 30b and can be electrically connected to the battery 60 via an ignition key switch 70. A plunger returning spring 30e that when a power supply to the actuator 30 is stopped (the ignition key switch 70 is opened), returns the plunger 30c attracted into the actuator 30 to an original position. This action of this plunger returning spring 30e disengages the pinion gear 26b from the ring gear 28. The plunger 30c is mechanically coupled to the roller clutch 25 via a shift lever 31.

An electric power supply system supplies DC electric power supplied from the battery 60 of the automobile-mounted battery to the actuator 30 and the motor 10. The electric power supply system is constructed of a first electric power supply path and a second power supply path. The first electric path is a power line from the positive pole of the battery 60 to the positive pole (electric power receiving terminal 30d) of the actuator 30 via the ignition key switch 70. The second electric power supply path is a power line from the positive pole of the battery 60 to the positive pole (electric power receiving terminal 22) of the motor 10 via a power switching unit 50. The first electric power supply path is independent of the second electric power supply path. The negative pole of the battery 60, the negative pole of the actuator 30, and the negative pole of the motor 10 are grounded to the vehicle body of the automobile, respectively.

The power switching unit 50 is control means for controlling an electric power supply from the battery 60 to the motor 10 according to the state of the electric power supply from the battery 60 to the actuator 30. To be specific, the power switching unit 50 is a switching means provided in the second electric power supply path for supplying the electric power supplied from the battery 60 to the motor 10. The power switching unit 50 is constructed of an n-channel enhancement type MOS-FET 50b (hereinafter simply referred to as MOS-FET 50b) that is a semiconductor device and a control circuit 50a for controlling the MOS-FET 50b according to the state of the electric power supply from the battery 60 to the actuator 30.

The control circuit 50a is constructed of an edge detecting part, a control signal generating part, and a voltage boosting circuit. The edge detecting part detects a rise of signal when the ignition key switch 70 is turned on, that is, that a supply of the electric power from the battery 60 to the actuator 30 is started. When the edge detecting part detects the rise of signal caused by turning on the ignition key switch 70, the control signal generating part generates a control signal of a predetermined duty factor (duty ratio) from a relationship of the duty factor of the control signal to time after the rise of the signal caused by turning on the ignition key switch 70. The voltage boosting circuit is constructed of a charge pump circuit or the like and applies voltage to the gate of the MOS-FET 50b based on the control signal outputted from the control signal generating part.

The relationship of the duty factor (duty ratio) of the control signal to the time after the rise of the signal caused by turning on the ignition key 70 is previously set based on the moving speed and travel distance of the pinion 26. Thereby, an intermittent voltage (pulse-shaped voltage) is applied to the gate of the MOS-FET 50b from the voltage boosting circuit in a predetermined time after the rise of the signal caused by turning on the ignition key switch 70 (after a supply of electric power from the battery 60 to the actuator 30 is started).

The voltage applied to the gate of the MOS-FET 50b from the voltage boosting circuit is set sufficiently higher than the voltage applied to the source electrode of the MOS-FET 50b. The MOS-FET 50b is intermittently repeatedly turned on and off by an intermittent voltage (pulse-shaped voltage) applied by the voltage boosting circuit. In this manner, the electric power from the battery 60 is supplied to the motor 10 intermittently (in a pulsating manner).

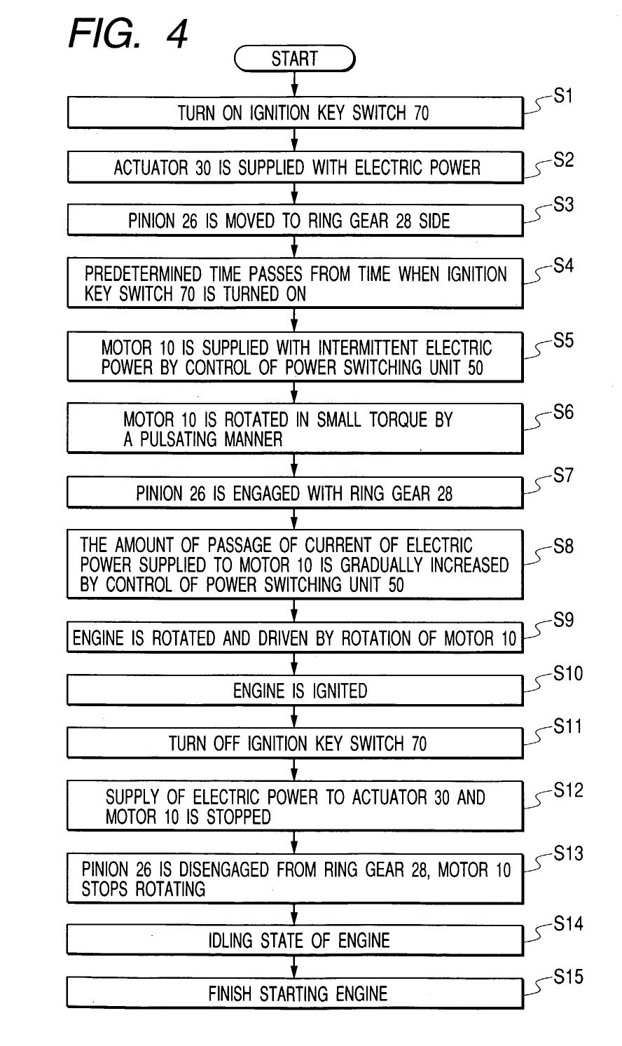

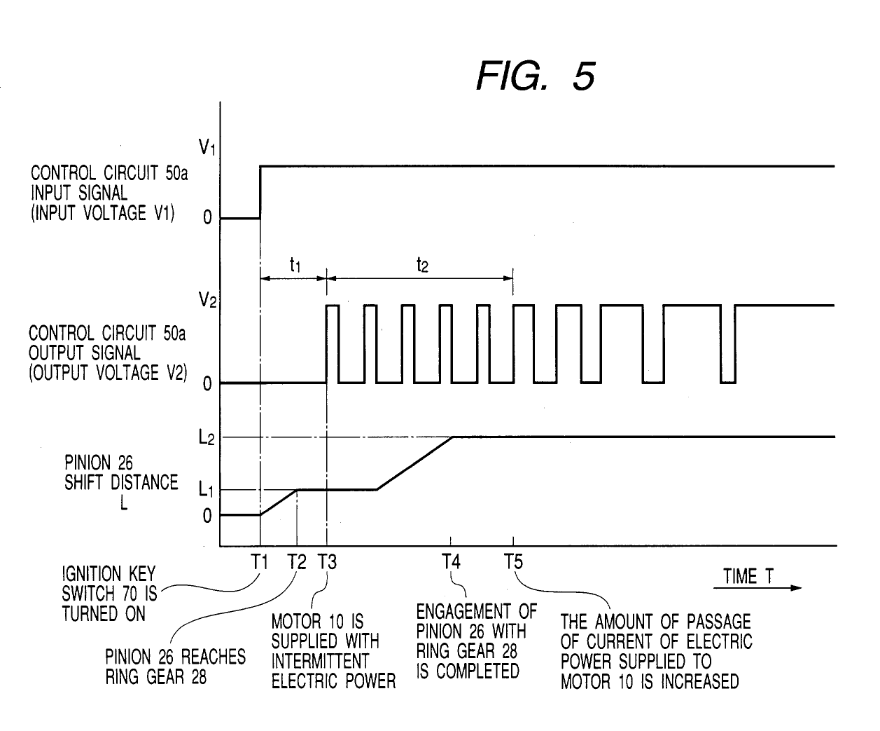

Next, the operation of the internal combustion engine starting device of the present embodiment will be described. FIG. 4 shows a series of operations from turning on the ignition key switch 70 to finishing starting of the automobile engine in the internal combustion engine starting device of the present embodiment. FIG. 5 shows a relationship between the input/output signal (input voltage V₁, output voltage V₂) of the control circuit 50a and a travel distance L of the pinion 26 in the internal combustion engine starting device of the present embodiment.

In the state shown in FIG. 2, when the ignition key switch 70 is turned on at the time T₁ shown in FIG. 5 (step S1), the battery 60 supplies the electric power to the actuator 30 via the ignition key switch 70 (step S2). In the actuator 30 supplied with the electric power, its solenoid coil 30b is excited to generate an electromagnetic induction force (attracting force) thereby to move the plunger 30c into the actuator 30 (to the electric power receiving terminal 30d side).

The roller clutch 25 is pushed out to the ring gear 28 side along with the movement of the plunger 30c thereby to move the pinion 26 to the ring gear 28 side in the direction of the rotary shaft 17 (step S3). The end face (of the ring gear 28 side) of the pinion 26 reaches the end face of the ring gear 28 (end face of the pinion 26 side) at the time T₂ shown in FIG. 5. That is, the pinion 26 travels a distance L1 from its original position in a time difference ΔT (=T₂−T₁).

At this time, in a case where the teeth of the pinion gear 26b are opposite to gaps between the teeth of the ring gear 28, the pinion 26 is directly engaged with the ring gear 28. That is, the pinion 26 travels a distance L₂ from its original position. In a case where the teeth of the pinion gear 26b are not opposite to gaps between the teeth of the ring gear 28, the pinion 26 is not engaged with the ring gear 28, but is held in a state where it is pressed on the end face of the pinion 26 side of the ring gear 28 by the driving force of the actuator 30.

Moreover, when the ignition key switch 70 is turned on at the time T₁ shown in FIG. 5, the input voltage V₁ is applied to the control circuit 50a. The applied voltage V₁ is detected by the edge detecting part. The detection result is inputted to the control signal generating part as a detection signal.

At the time T₃ shown in FIG. 5, that is, after a predetermined time t₁, for example, 0.2 second to 0.5 second from the time when the ignition key switch 70 is turned on, or after the lapse of time ΔT (=T₃−T₂) from the time when the end face of the pinion 26 (end face of the ring gear 28 side) reaches the end face of the ring gear 28 (end face of the pinion 26 side), the control signal generating part outputs a control signal to the voltage boosting circuit based on the relationship of the duty factor (duty ratio) of the control signal to the time after the rise of the signal caused by turning on the ignition key switch 70.

The voltage boosting circuit is controlled based on the inputted control signal and applies an intermittent output voltage (pulse-shaped output voltage) V₂ as an output signal to the gate of the MOS-FET 50b. The MOS-FET 50b is intermittently repeatedly turned on and off by the applied output signal. The electric power supplied from the battery 60 is supplied as an intermittent electric power having a duty factor of current of 80% or less, preferably, 20%, to the field winding and the rotator winding 15 of the motor 10 (step S5).

Here, it's assumed that the lapse (passing) time after the pinion 26 started moving to the ring gear 28 side (at the time T₁ shown in FIG. 5) until the pinion 26 (end face of the ring gear 28 side) reaches the end face (pinion 26 side) of the ring gear 28 (at the time T₂ shown in FIG. 5) is Tm (time difference ΔT (=T₂−T₁)). And it's assumed that the lapse of time after the ignition key switch 70 was turned on (at the time T₁ shown in FIG. 5, that is, the battery 60 starts supplying the electric power to the actuator 30) until the motor 10 is supplied with the intermittent electric power (at the time T₃ shown in FIG. 5) is Tp (time difference ΔT (=T₃−T₁). The starter 100 in the present embodiment satisfies the following relationship.

Tp≧Tm

As is clear from this relationship, in the present embodiment, the intermittent electric power is delayed and supplied to the motor 10 after the pinion 26 started moving to the ring gear 28 side, that is, the ignition key switch 70 is turned on (or the battery 60 starts supplying the electric power to the actuator 30). In other words, in the present embodiment, the intermittent voltage (pulse-shaped voltage) is delayed and supplied to the gate of the MOS-FET 50b such that the intermittent electric power is delayed and supplied to the motor 10 via the power switching unit 50.

The motor 10 supplied with the intermittent electric power is intermittently (in a pulsating manner) rotated by a rotating driving force (torque) that corresponds to the amount of current of the intermittent electric power and is smaller than a rotating driving force necessary for starting the automobile engine (step S6). This rotation is transmitted to the pinion 26 via the rotary shaft 17 and the roller clutch 25 to intermittently rotate the pinion 26. In a case where the pinion 26 is not engaged with the ring gear 28 but is pressed onto the end face of the pinion 26 side of the ring gear 28 by the driving force of the actuator 30, this rotation adjusts the relative position of the teeth of the pinion gear 26b to the teeth of the ring gear 28 and engages the pinion 26 with the ring gear 28 at a stage where the teeth of the pinion gear 26b are brought to a relative position opposite to the teeth of the ring gear (step S7). When the pinion 26 is engaged with the ring gear 28 and the plunger 30c is attracted to a maximum attraction position at the time T₄ shown in FIG. 5, the engagement of the pinion 26 with the ring gear 28 is completed (brought into the state shown in FIG. 3).

After the engagement of the pinion 26 with the ring gear 28 is completed, at the time T₅ shown in FIG. 5, that is, after the lapse of time t₂ shown in FIG. 5 from the time when the supply of the intermittent electric power to the motor 10 is started (time T₃ shown in FIG. 5), or after the lapse of time ΔT=T₅−T₄ from the time when the pinion 26 is engaged with the ring gear 28 (at the time T₄ shown in FIG. 5), the power switching unit 50 gradually increases the amount of current of the intermittent electric power supplied to the motor 10 (step S8). That is, the power switching unit 50 generates the control signal based on the relationship of the duty factor (duty ratio) of the control signal to the time after the rise of signal caused by turning on the ignition key switch 70 such that the amount of current of the intermittent electric power supplied to the motor 10 gradually increases. Then, the power switching unit 50 controls the voltage boosting circuit by the control signal. The voltage boosting circuit applies the intermittent voltage (pulse-shaped output voltage) V2 corresponding to the control signal to the gate of the MOS-FET 50b, thereby controls the MOS-FET 50b.

When the amount of current of the intermittent electric power supplied to the motor 10 by the control of the power switching unit 50 gradually increases, the rotational driving force of the motor 10 gradually increases. This gradually rotates the automobile engine with the increasing number of revolutions (step S9). When the number of revolutions of the automobile engine reaches a predetermined range of the number of revolutions of the automobile engine, the automobile engine is ignited (step S10). When the ignition of the automobile engine is determined, the ignition key switch 70 is turned off (step S11).

When the ignition key switch 70 is turned off, the supply of the electric power from the battery 60 to the actuator 70 is stopped (step S12). Then the solenoid coil 30b of the actuator 30 is brought into an unexcited state and ceased to generate the electromagnetic induction force (attracting force). Then, the plunger 30c is moved toward the initial position (where it is protruded to the maximum from the end opposite to the electric power receiving terminal 30d side of the actuator 30 (state shown in FIG. 2)). Then, with this movement of the plunger 30c, the roller clutch 25 and the pinion 26 is moved opposite to the ring gear 28, whereby the pinion 26 is separated from the ring gear 28, that is, the pinion 26 is disengaged from the ring gear 28 (step S13).

Moreover, when the ignition key switch 70 is turned off at the step S11, the supply of the electric power from the battery 60 to the motor 10 is stopped by the control of the power switching unit 50 (step 12), thereby the motor 10 stops rotating. Here, while the pinion 26 is engaged with the ring gear 28, the motor 10 is driven by the automobile engine and keeps rotating. When the pinion 26 is separated from the ring gear 28 at the step S13, the motor ceases rotating naturally. After the automobile engine is ignited, it is operated in an idling state, that is, in the range of the idling number of revolutions (step S14). In this manner, the starter 100 finishes starting the automobile engine (step S15).

According to the present embodiment described above, the electric power supply paths for supplying the electric power to the actuator 30 and the electric power supply paths for supplying the electric power to the motor 10 from the battery 60 are constructed independently of each other, so that the electric power supplied to the actuator 30 from the battery 60 is not supplied to the motor 10. With this construction, an exciting current flowing through the solenoid coil 30b of the actuator 30 becomes small and hence the electromagnetic induction force (attracting force) generated in the actuator 30 and driving the plunger 30c becomes small. Thus, it is possible to decrease the moving speed of the plunger 30c and hence to decrease the moving speed of the pinion 26 moving to the ring gear 28 side. Therefore, according to the present embodiment, it is possible to decrease the impact force caused by the collision of the pinion 26 with the ring gear 28 without providing means for decreasing an impact force generated when the pinion collides with the ring gear 28, in the pinion 26.

In addition, according to the present embodiment, it is sufficient that the actuator 30 generates a driving force of such a level that can move the pinion 26 to the ring gear 28 side and keep the contact state of the pinion 26 with the ring gear 28. Therefore, according to the present embodiment, it is possible to make the size of the actuator 30 smaller than a usual one and to simplify the construction of the actuator 30.

Therefore, according to the present embodiment, it is possible to reduce the size, weight and cost of the starter 100, to elongate its life, thus to improve the cost effectiveness and quality assurance of the starter 100. Moreover, the starter 100 of the present embodiment is especially effective in compatibly improving reliability and cost effectiveness in the automobile having an idle stop system applied thereto in which every time the automobile is stopped to wait at traffic signals or the like, the engine is stopped and when the automobile is restarted, the engine is restarted.

Further, according to the present embodiment, it is possible to supply the electric power to the motor 10 from the battery 60 without via the actuator 30, so that the actuator 30 is not required to have a mechanical contact. Therefore, according to the present embodiment, it is possible to improve the durability of the actuator 30 and to reduce the size, weight and cost of the actuator 30, thus to reduce the size, weight and cost of the starter 100 and to elongate the life thereof.

Still further, according to the present embodiment, the ignition key switch 70 is turned on, the pinion 26 moves to the ring gear 28 side, thereby the pinion 26 contacts with the ring gear 28, and then the power switching unit 50 delays the electric power and supplies it to the motor 10. Therefore, it is possible to decrease the impact force caused when the pinion 26 is engaged with the ring gear 28. Moreover, in a case where the pinion 26 is not engaged with the ring gear 28, by intermittently driving the motor 10 by the intermittent electric power, it is possible to engage the pinion 26 with the ring gear 28 surely and with a decreased rotational impact force between the pinion 26 and the ring gear 28 caused when the pinion 26 is engaged with the ring gear 28. Therefore, according to the present embodiment, it is possible to improve there liability of the starter 100 and to suppress the wearing and chipping of the pinion 26 and hence to further elongate the starter 100.

Still further, according to the present embodiment, the duty factor of current of the intermittent electric power when the pinion 26 is engaged with the ring gear 28 is reduced to 80% or less, preferably 20% to reduce the amount of current of the electric power supplied to the motor 10. Thus, it is possible to further reduce the rotational driving force of the motor 10 in addition to the action of reducing the rotational driving force of the motor 10 by the intermittent driving of the motor 10. Therefore, according to the present embodiment, it is possible to further decrease the rotational impact force between the pinion 26 and the ring gear 28.

Still further, according to the present embodiment, the power switching unit 50 can be separated from the motor 10 and the actuator 30. Thereby, the power switching unit 50 can be located at a position away from a high-temperature region around the internal combustion engine with the motor 10 and the actuator 30. Thus, it is possible to improve the heat resistance of the power switching unit 50 without subjecting it to a heat-resistant treatment. Therefore, according to the present embodiment, it is possible to standardize the power switching unit 50 and thus to further reduce the cost of the starter 100.

Still further, according to the present embodiment, the power switching unit 50 can be separated from the motor 10 and the actuator 30, so that it is possible to increase flexibility in the arrangement of the starter 100. Therefore, it is possible to improve flexibility in mounting the starter 100 on a vehicle.

Still further, according to the present embodiment, the current flowing through the solenoid coil 30b of the actuator 30 becomes small, so that a starter relay interposed between the battery 60 and the actuator 30 in the prior art does not need to be interposed between the battery 60 and the actuator 30. Therefore, according to the present embodiment, it is possible to further reduce the size, weight, and cost of the starter 100 and to further elongate its life.

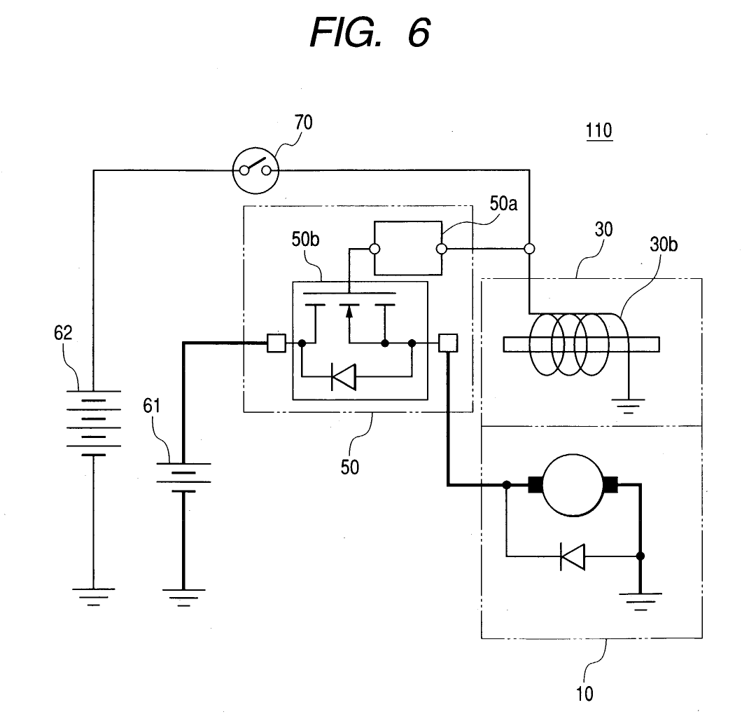

Next, a second embodiment of the invention will be described with reference to FIG. 6. FIG. 6 shows the electric circuit configuration of an internal combustion engine starting device that is the second embodiment of the invention. The internal combustion engine starting device of the second embodiment is a starter for starting an engine of a hybrid automobile. The hybrid automobile switches, according to the driving state of the vehicle, between the driving force of the engine driven by supplying with fuel for example gasoline and the driving force of a motor driven by supplying with the electric power from a battery of a vehicle-mounted power source.

In recent years, from the viewpoint of environmental protection or global warming prevention, developments are being made in an idle stop system in which when the vehicle stops to wait at traffic signals, the engine is stopped to suppress the emission of exhaust gas. In the idle stop system, even when the engine is stopped, a large amount of electric power is required because an air conditioner or the like is continuously operated. For this reason, in the automobile having the engine as a driving source, the output voltage of the battery is increased from 12 V to 36 V. Moreover, the hybrid automobile having the engine and the motor as driving sources is mounted with a battery having an output voltage of 36 V in addition to a battery already mounted and having an output voltage of 12 V.

Then, in the present embodiment, in the hybrid automobile, the electric power supply sources for the motor 10 and the actuator 30 are separated from each other. To be more specific, the electric power supply system is constructed in such a way that the motor 10 is driven by the electric power supplied from a battery 61 having an output voltage of 12 V. The actuator 30 is driven by the electric power supplied from a battery 62 having an output voltage of 36 V. Here, other construction is the same as the above embodiment, so the specific description of the other construction will be omitted.

According to the present embodiment described above, the battery 61 having an output voltage of 12 V supplies the electric power to the motor 10 and the battery 62 having an output voltage of 36 V supplies the electric power to the actuator 30, respectively. That is, the electric power supplied to the actuator 30 is higher in voltage than the electric power supplied to the motor 10. Thereby, it is possible to increase the electromagnetic induction force (attracting force) of the actuator 30. Thus, according to the present embodiment, it is possible to provide the actuator 30 with a predetermined driving force (as small a driving force as can move the pinion 26 to the ring gear 28 side and hold the state of contact of the pinion 26 with the ring gear 28) and to further reduce the size of the actuator 30. Therefore, according to the present embodiment, it is possible to further reduce the size, weight, and cost of the starter 110 and to improve flexibility in mounting the starter 110 on the vehicle.

Further, according to the present embodiment, the motor 10 can be supplied with the electric power of 12 V voltage as usual, so that the specification of the motor 10 does not need to be changed but the motor of the same specification as before can be used. Therefore, according to the present embodiment, it is possible to standardize the starter 110 and hence to prevent an increase in the cost of the starter 110.

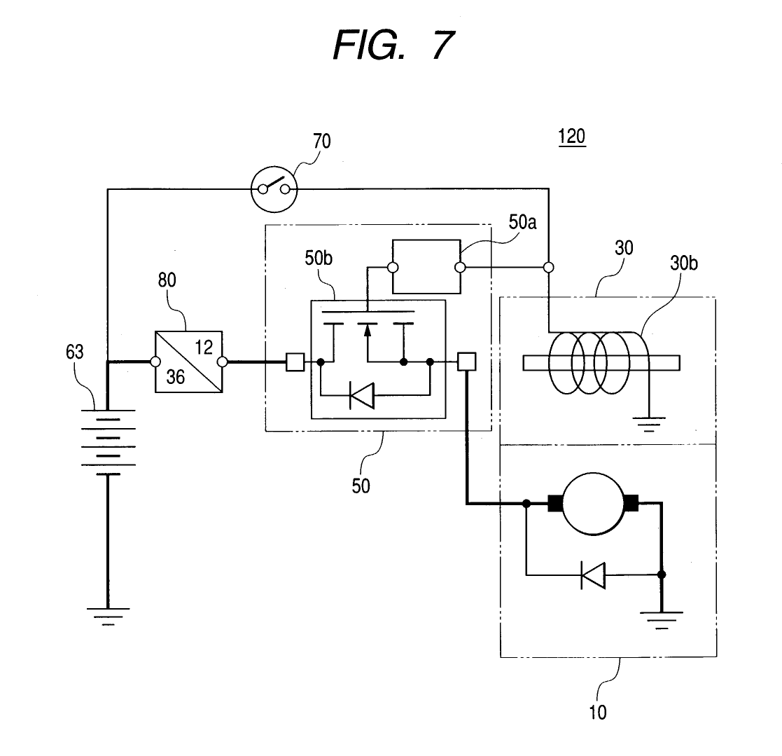

Next, a third embodiment of the invention will be described with reference to FIG. 7. FIG. 7 shows the electric circuit configuration of an internal combustion engine starting device that is the third embodiment of the invention. The internal combustion engine starting device of the third embodiment is a starter for starting an engine of an automobile driven by an engine that is supplied with fuel, for example, gasoline. As described in the above embodiment, in this device, the voltage of the battery is increased (output voltage is increased from 12 V to 36 V) by the use of the idle stop system.

The starter 120 of the present embodiment responds to the increasing voltage of the battery. That has an electric power supply system in which a DC-DC converter 80 as electric power converter is provided at a midpoint of an electric power supply path for supplying electric power to the motor 10 from a battery 63 having an output voltage of 36 V. The DC-DC converter converts the voltage of the electric power supplied from the battery 63 from 36 V to 12 V (which is equal to the input voltage of the motor 10). The electric power of the decreased voltage of 12 V is supplied to the motor 10 via the power switching unit 50. The actuator 30 is supplied with the electric power (having an output voltage of 36 V) supplied from the battery 63. Here, the other construction is the same as the above embodiment, so the specific description of the other construction will be omitted.

According to the present embodiment described above, the actuator 30 is supplied with the electric power from the battery 63 having an output voltage of 36 V. The motor 10 is supplied with the electric power from the battery 63 with its voltage decreased from 36 V to 12 V. That is, as is the case with the above embodiment, the actuator 30 is supplied with the electric power of higher voltage than the electric power supplied to the motor 10, so that the electromagnetic induction force (attracting force) of the actuator 30 can be increased. Thus, also in the present embodiment, it is possible to provide the actuator 30 with a predetermined driving force (a driving force of such a level that can move the pinion 26 to the ring gear 28 side and hold the state of contact of the pinion 26 with the ring gear 28) and to further reduce the size of the actuator 30. Therefore, according to the present embodiment, as in the case of the above embodiment, it is possible to further reduce the size, weight, and cost of the starter 120 and to improve flexibility in mounting the starter 120 on the vehicle.

Further, according to the present embodiment, the motor 10 can be supplied with the electric power of 12 V voltage as usual, so that the specification of the motor 10 does not need to be changed but the motor of the same specification as before can be used. Therefore, according to the present embodiment, it is possible to standardize the starter 120 and hence to prevent an increase in the cost of the starter 120.

Incidentally, in the present embodiment, an application of the invention to the automobile in which the vehicle-mounted battery is increased in voltage (output voltage is increased from 12 V to 36 V), but the construction of the starter 120 in this embodiment can be applied also to a case where in the hybrid automobile of the second embodiment, only the battery 62 having an output voltage of 36 V is the driving power source of the motor 10 and the actuator 30.

### INDUSTRIAL APPLICABILITY

According to the invention described above, even if a means for decreasing the impact force is not provided in the transmission unit, it is possible to decrease the impact force caused by the collision of the transmission unit to the power transmitting part of the internal combustion engine. Further, it is possible to reduce the size of the driving unit as compared with a conventional one and to simplify the construction of the driving unit. Still further, it is possible to eliminate the need for providing the driving unit with a mechanical contact and to further miniaturize and simplify the driving unit and to improve the durability of the driving unit. This leads to reducing the size, weight, and cost of the internal combustion engine starting device and elongating its life. Therefore, according to the invention, it is possible to improve the cost effectiveness and quality assurance of the internal combustion engine starting device. In particular, the invention is effective in improving the reliability and cost effectiveness of the automobile to which the idle stop system is applied.

What is claimed is:

1. An internal combustion engine starting device comprising:
a rotational electric machine that generates a rotational driving force for starting the internal combustion engine by a supply of electric power from a power source,
a transmission unit that transmits the rotational driving force to a power transmitting part of the internal combustion engine side and can be mechanically engaged with or disengaged from the power transmitting part,
a driving unit that moves the transmission unit toward the power transmitting part of the engine side on a rotary shaft of the rotational electric machine by a supply of electric power from the power source, and
a control means that controls a supply of electric power supplied from the power source to the rotational electric machine according to a state of a supply of the electric power supplied from the power source to the driving unit,
wherein an electric power supply path for supplying the rotational electric machine with electric power from the power source and an electric power supply path for supplying the driving unit with electric power from the power source are mutually constituted independently.

2. The internal combustion engine starting device as claimed in claim 1, wherein the control means is located separately from the driving unit and the rotational electric machine.

3. The internal combustion engine starting device as claimed in claim 1, wherein the control means is a switching means that supplies intermittent electric power from the power source to the rotational electric machine delaying according to the state of the supply of electric power supplied from the power source to the driving unit.

4. The internal combustion engine starting device as claimed in claim 1, wherein an output voltage of the power source is set higher than an input voltage of the rotational electric machine, and the rotational electric machine is supplied with electric power having the decreased voltage from the power source.

5. The internal combustion engine starting device as claimed in claim 1, wherein the power source is comprised of a first power source and a second power source that are different from each other in an output voltage; the rotational electric machine is supplied with electric power from the first power source, and the driving unit is supplied with electric power from the second power source whose output voltage is higher than the first power source.

6. The internal combustion engine starting device as claimed in claim 1, wherein the power source has an output voltage of 36 V, and the rotational electric machine is supplied with electric power from the power source and whose voltage is decreased to 12 V.

7. The internal combustion engine starting device as claimed in claim 1, wherein the power source is comprised of a first power source having an output voltage of 12 V and a second power source having an output voltage of 36 V; the rotational electric machine is supplied with electric power from the first power source, and the driving unit is supplied with electric power from the second power source.

8. A method for driving an internal combustion engine starting device comprising:
a process for generating a rotational driving force, in a rotational electric machine used as a starting motor, by supplying with electric power from a power source,
a process for moving a transmission unit of the rotational electric machine toward a power transmitting part of the internal combustion engine side on a shaft of the rotational electric machine by a driving unit driven by supplying of electric power from the power source, thereby the transmission unit engages with the power transmitting part of the engine side, and the rotational driving force is transmitted to the engine, wherein a supply of electric power from the power source to the rotational electric machine and a supply of electric power from the power source to the driving unit are independent of each other.

9. A method for driving an internal combustion engine starting device comprising:
a process for generating a rotational driving force, in a rotational electric machine used as a starting motor, by supplying with electric power from a power source,
a process for moving a transmission unit of the rotational electric machine toward a power transmitting part of the internal combustion engine side on a shaft of the rotational electric machine by a driving unit driven by supplying of electric power from the power source, thereby the transmission unit engages with the power transmitting part of the engine side, and the rotational driving force is transmitted to the engine, wherein after the driving unit is supplied with electric power from the power source and a predetermined time passes, the rotational electric machine is intermittently supplied with electric power from the power source independently of a supply of electric power to the driving unit.

10. A method for driving an internal combustion engine starting device comprising:
a process for generating a rotational driving force, in a rotational electric machine used as a starting motor, by supplying with electric power from a power source,
a process for moving a transmission unit of the rotational electric machine toward a power transmitting part of the internal combustion engine side in a direction of the shaft of the rotational electric machine by a driving unit driven by supplying of electric power from the power source, thereby the transmission unit engages with the power transmitting part of the engine side, and the rotational driving force is transmitted to the engine,
wherein assuming that a passing time after the transmission unit started moving in the direction of the shaft until it reaches the power transmitting part is Tm; assuming that a passing time after the power source started supplying the driving unit with electric power until the power source starts supplying the rotational electric machine with electric power is Tp, the power source supplies the driving unit with electric power such that a relationship of
Tp≧Tm
is satisfied, and then the rotational electric machine is intermittently supplied with electric power from the power source independently of a supply of electric power to the driving unit.

11. A method for driving an internal combustion engine starting device comprising:
a process for generating a rotational driving force, in a rotational electric machine used as a starting motor, by supplying with electric power from a power source,
a process for moving a transmission unit of the rotational electric machine toward a power transmitting part of the internal combustion engine side on a shaft of the rotational electric machine by a driving unit driven by supplying of electric power from the power source, thereby the transmission unit engages with the power transmitting part of the engine side, and the rotational driving force is transmitted to the engine, wherein after the driving unit is started supplying with electric power from the power source, the rotational electric machine is intermittently supplied with electric power from the power source accompanied by delay via a switching element, which is provided in an electric power supply path used for the rotational electric machine independent of an electric power supply path used for the driving unit and controlled based on the state of a supply of the electric power to the driving unit.

12. A method for driving an internal combustion engine starting device comprising:
a process for generating a rotational driving force, in a rotational electric machine used as a starting motor, by supplying with electric power from a power source,
a process for moving a transmission unit of the rotational electric machine toward a power transmitting part of the internal combustion engine side in a direction of the shaft of the rotational electric machine by a driving unit driven by supplying of electric power from the power source, thereby the transmission unit engages with the power transmitting part of the engine side, and the rotational driving force is transmitted to the engine,
wherein assuming that a passing time after the transmission unit started moving in the direction of the rotary shaft until it reaches the power transmitting part is Tm; assuming that a passing time after the power source started supplying the driving unit with electric power until the power source started supplying the rotational electric machine with electric power is Tp, the power source supplies the driving unit with electric power such that a relationship of
Tp≧Tm
is satisfied, and then the rotational electric machine is intermittently supplied with electric power from the power source accompanied by delay via a switching element, which is provided in an electric power supply path used for the rotational electric machine independent of an electric power supply path used for the driving unit and controlled based on the state of a supply of the electric power to the driving unit.

13. The method for driving an internal combustion engine starting device, as claimed in claim 8, wherein an output voltage of the power source is set higher than an input voltage of the rotational electric machine, and a supply of electric power to the rotational electric machine from the power source is performed after its voltage is decreased.

14. The method for driving an internal combustion engine starting device, as claimed in claim 8, wherein the power source outputs a first electric power and a second electric power that are different from each other in an output voltage, and the first electric power is supplied to the rotational electric machine and the second electric power whose output voltage is higher than the first electric power is supplied to the driving unit.

15. The method for driving an internal combustion engine starting device, as claimed in claim 8, wherein a duty factor of current of electric power supplied to the rotational electric machine is 80% or less.

16. The method for driving an internal combustion engine starting device, as claimed in claim 8, wherein the amount of current of electric power supplied to the rotational electric machine is set a regular value for a predetermined time after starting to supply the rotational electric machine with electric power, and then after the predetermined time passes, the amount of current of electric power supplied to the rotational electric machine is gradually increased.

17. The method for driving an internal combustion engine starting device, as claimed in claim 8, wherein an output voltage of the power source is 36 V, and a supply of electric power to the rotational electric machine from the power source is performed after its voltage is decreased to 12 V.

18. The method for driving an internal combustion engine starting device, as claimed in claim 8, wherein the power source outputs a first electric power having an output voltage of 12 V and a second electric power having an output voltage of 36 V, and the first electric power is supplied to the rotational electric machine and the second electric power is supplied to the driving unit.
